(19) United States
(12) Patent Application Publication
(10) Pub. No.: US 2014/0126981 A1
(43) Pub. Date: May 8, 2014

(54) Insertion of Inserts into Channels of a Catalytic Reactor

(71) Applicants: Mark Le Sueur, Wiltshire (GB); Richard Matthews, Leicestershire (GB)

(72) Inventors: Mark Le Sueur, Wiltshire (GB); Richard Matthews, Leicestershire (GB)

(73) Assignee: CompactGTL Limited, Redcar Cleveland (GB)

(21) Appl. No.: 14/129,154

(22) PCT Filed: Jun. 7, 2012
(86) PCT No.: PCT/GB2012/051273

§ 371 Date: Dec. 24, 2013

(30) Foreign Application Priority Data
Jun. 28, 2011 (GB) 1110913.9

(51) Int. Cl. B01J 19/24

(52) U.S. Cl. CPC B01J 19/24
USPC 414/226.04; 414/806

(57) ABSTRACT

An automated insertion apparatus for inserting at least one insert into each of a multiplicity of reactor channels. The apparatus comprises a feed position that supports a magazine that holds a multiplicity of inserts, and a transport mechanism defining at least two support channels each configured to hold a single insert, and means to transport each support channel repeatedly between an input location adjacent to the feed position and an output location, and means to feed one insert from a magazine at the feed position into a support channel of the transport mechanism at the input location. The apparatus also includes a transfer mechanism to push an insert into a reactor channel, and an alignment mechanism to ensure that the insert that is being inserted is aligned with the reactor channel. The transfer mechanism is adjacent to the output location. The transport mechanism may be a rotary drum.

This invention relates to an improved apparatus and method for inserting inserts into channels of a catalytic reactor. Such inserts may carry catalytic material.

Catalytic reactors provide an environment in which the speed and efficiency of a chemical reaction can be improved using a catalyst. Many different types of reactions can be catalysed, for example combustion, steam methane reforming and Fischer-Tropsch synthesis; these may all be used in a Gas-to-Liquid conversion process. Different types of catalytic reactor are known for GTL conversion process, for example slurry bed reactors, fixed bed reactors and compact reactors. Compact reactors comprise a multiplicity of channels extending through a reactor block, so providing a large surface area for heat exchange within a different volume of reactor. In a compact reactor the catalyst is provided on a surface and the reagents are brought into contact with that surface. Coating walls of the channels with catalyst material is feasible, but to maximize the volume of the reagents that is brought into contact with the catalyst, the channels would have to be very small. It has therefore been suggested that the catalyst may be mounted onto one or more metal structures, which may therefore be referred to as catalyst-carrying inserts, that are introduced into each of the reactor channels. Each insert may be of substantially the same length as the channel into which it is inserted.

For example such an insert may be a honeycomb structure, a finned structure, or may comprise one or more corrugated foils. Such inserts provide a large surface area for catalyst within a small volume, and the insert may have sufficiently high voidage that the flow of reactants through the channel is not unduly impeded. In addition, if there is a risk that the catalyst may become spent during use, the useful lifetime of the reactor as a whole can be readily increased by simply replacing the catalyst inserts.

A large reactor may define several thousand reactor channels, so that insertion of the inserts can be time-consuming. The insertion must also be carried out carefully to avoid damaging the insert and to avoid the risk of obstructing the flow channel. This can be problematic because the cross-sectional area of the insert is typically only slightly less than that of the channel itself, to minimise the extent to which the reactants may bypass the insert. Furthermore, ceramic coated inserts are highly abrasive and so difficult to handle. Because of manufacturing tolerances there is inevitably a risk that an insert may become jammed during insertion, and an automated system for inserting inserts should be able to cope with this problem.

An apparatus for inserting catalyst supports into reaction channels is described in WO 2010/046700 (CompactGTL plc), but an improved apparatus that can operate more rapidly, and more reliably deal with any jammed inserts, would be desirable.

According to the present invention there is provided an insertion apparatus for inserting at least one insert into each of a plurality of reactor channels, the apparatus comprising:

means to support a magazine at a feed position, the magazine being configured to locate a multiplicity of inserts;

a transport mechanism defining at least two support channels each configured to hold a single insert, and means to transport each support channel repeatedly between an input location adjacent to the feed position and an output location;

a feed mechanism to feed one insert from a magazine at the feed position into the support channel of the transport mechanism at the input location;

a transfer mechanism for transferring an insert from the output location of the transport mechanism into a reactor channel; and

an alignment mechanism to ensure that the insert that is being transferred into a reactor channel is aligned with the reactor channel.

The transport mechanism may define a multiplicity of support channels which are arranged to pass through at least one intermediate location between the input location and the output location, and arranged such that the support channels that hold an insert are moved stepwise between successive locations.

The transport mechanism separates the input location from the output location, and so makes more rapid operation feasible, as an insert can be fed into one of the support channels simultaneously with insertion of an insert into a reactor channel. If the transport mechanism defines a multiplicity of support channels which pass through such intermediate locations, then it provides a buffer against any delay in the provision of inserts at the input location, by virtue of inserts at each intermediate location; for example when an empty magazine is replaced by a full magazine, the time taken to perform that replacement need not affect the insertion process, as the transport mechanism may be actuated to move forward through a plurality of steps without stopping, until the next insert reaches the output location.

The present invention is applicable to any reactor block in which there are a multiplicity of reaction channels into which inserts such as catalyst-carrying inserts are to be inserted. The reactor block itself may comprise a stack of plates. For example, first and second flow channels may be defined by grooves in respective plates, the plates being stacked and then bonded together. Alternatively the flow channels may be defined by thin metal sheets that are castellated and stacked alternately with flat sheets; the edges of the flow channels may be defined by sealing strips. The nature of the first and second flow channels would depend upon the reaction or reactions that are to occur in the reactor block. For example channels for an exothermic chemical reaction may be arranged alternately in the stack with channels for an endothermic reaction; in this case appropriate catalysts would have to be inserted into each channel. For example the exothermic reaction may be a combustion reaction, and the endothermic reaction may be steam methane reforming. In other cases channels for a chemical reaction (first channels) may be arranged alternately in the stack with channels for a heat transfer medium, such as a coolant. In this case catalytic inserts would only be required in the first channels. For example the first channels may be for performing the Fischer-Tropsch reaction, and the heat transfer medium would in this case be a coolant.

In one embodiment the transport mechanism comprises a rotary support structure having an axis of rotation and defining a multiplicity of support channels each configured to hold a single insert, the support channels being at locations that in transverse cross-section define a regular polygon centred on the axis of rotation. In one embodiment the support channel at the input location is diametrically opposite the support channel at the output location. For example the axis of rotation may be horizontal, the input location being above the axis of rotation and the output location being below the axis of rotation. The rotary support structure may be a cylindrical drum with eight support channels equally spaced around its periphery. The drum may rotate within a cover which ensures that inserts cannot fall out of the support channels as the drum rotates. The dimensions of a support channel may be selected to ensure the insert can easily slide along the channel, so for example the width of the support channel would preferably be at least 0.2 mm greater than the width of the insert.

The apparatus may comprise a guide element for guiding the movement of an insert as it is transferred into a reaction channel. The alignment mechanism may therefore comprise means to align the guide element with a reactor channel. In addition, the apparatus may further comprise means for monitoring the alignment of the guide element with the reactor channel. The means for monitoring may be a camera, preferably a digital camera. Such a digital imaging device may be combined with a light source. Alternatively, the monitoring means may use laser or ultrasound technology to monitor the alignment of the guide element.

The guide element may provide an aperture through which in use the insert is configured to pass. The aperture may be tapered along its length, and/or comprise a rollers, so that the insert is slightly compressed during passage through the guide element.

The magazine may define a multiplicity of grooves or chambers, wherein each groove or chamber is sized and configured to locate one insert. Alternatively, the magazine may define a single elongate groove in which a plurality of inserts may lie in an end to end configuration. The magazine with a plurality of grooves each sized for a single insert may be preferred as this minimizes the distance that each insert has to be pushed in order to insert it into the reactor. As the inserts may be highly abrasive it is preferable both for the integrity of any catalyst on the insert, but also for the magazine, to minimize the distance that each insert has to be pushed.

As another alternative, if the insert is in the form of a single item prior to insertion, the magazine may contain a stack of inserts on top of each other, and on each operation of the insertion apparatus one of the inserts is fed from the magazine into the support channel at the input location.

The transfer mechanism may comprise a pushing member to push an insert into the reactor channel. The pushing member may act on an insert in or adjacent to the output location. For example the transfer mechanism may comprise a linear actuator to move the pushing member.

The transfer mechanism may comprise other means for transferring the insert, for example one or more resiliently-mounted rollers in contact with the insert may be rotated to move the insert. The initial step of transferring the insert out of the support channel at the output location of the transport mechanism may be such that the insert falls out of the support channel into a position from which it is then transferred into the reactor channel. Alternatively the output location of the support channel may be aligned with the reactor channel sufficiently well that the insert can be pushed directly out of the support channel and into the reactor channel, for example through a guide element.

The transfer mechanism may be arranged to transfer the insert into the channel at an insertion speed which is constant, or at an insertion speed which varies during the course of the insertion. For example the insertion speed may be slow as the front end of the insert is transferred into the open end of the reactor channel; once the front end of the insert is within the reactor channel, the insertion speed may be increased. The insertion speed may increase continuously, or stepwise. Additionally or alternatively the transfer mechanism may be arranged to apply a variable force to the insert in the course of the insertion. In particular the force may be gradually increased, either continuously or stepwise, as the length of the insert within the channel increases.

The pushing member may comprise a pushing rod with an end face which may be configured to abut the insert, in use. The end face may be made of resilient plastic. The insertion mechanism may incorporate a sensor to monitor the force that is exerted on the insert. This enables a jammed insert to be detected.

Furthermore, according to the present invention there is provided a control system for controlling the insertion apparatus described above, comprising: a microprocessor configured to receive data from one or more sensors, an actuator configured to control the pushing member and an actuator configured to move at least part of the apparatus to provide alignment with a reactor channel.

One of the sensors may be a pressure sensor located on the pushing member. One of the sensors may be an optical sensor configured to determine the position of the channel. The actuator may further be configured to move at least part of the apparatus to provide alignment between the catalytic insert and the guide element. One of the sensors may be configured to confirm that a channel is correctly sized and not blocked. If a channel is identified that is blocked, then the control system will not attempt to insert an insert into such a channel. This will reduce the number of instances of failure of the apparatus resulting from an insert being part-inserted into a channel which is blocked or mis-sized. In addition, the control system may further comprise means for storing reactor layout information which is configured to record data from the sensor identifying blocked channels. The means for storing reactor layout information may be a memory that can be updated with further relevant data about the status of the channels in that reactor.

Moreover according to another aspect of the present invention there is provided an apparatus for removing an insert from a reactor channel. The removal apparatus may be associated with the insertion apparatus described above, and be activated if an insert becomes jammed before it has been fully inserted. A removal apparatus, suitable for removing an insert which is only partly inserted, comprises a cam which when actuated secures the position of the insert within a guide element; this may be operated in conjunction with means for withdrawing the guide element from the reactor, and thereby withdrawing the insert from the reactor channel.

An alternative removal apparatus suitable for use if the insert becomes jammed leaving only a short length protruding, for example less than 20 mm or less than 10 mm, comprises a fixing bar with a self-tapping screw at one end, and a frame defining a socket to fit the end of the insert, the socket having a tapered mouth, and defining an aperture at the opposite end of the frame, the self tapping screw being adapted to extend through the aperture to project within the socket. If the insert is partly projecting, the frame would be moved forward with the screw retracted so the end of the insert fits within the socket, and the screw would then be pressed on to the end of the insert while being rotated so that the screw engages with the insert. The screw and the frame would then be retracted, pulling the insert with them. This removal mechanism is also suitable for use if the insert is fully inserted into a channel. In this case the frame would be moved forward with the screw retracted until the socket is adjacent to and aligned with the end of the channel; the screw would then be pressed on to the end of the insert while being rotated, so that the screw engages with the insert; the screw would then be withdrawn, pulling the end of the insert into the socket; and then the screw and frame would be retracted together, pulling the insert with them.

As mentioned above the insert may comprise a honeycomb structure, a finned structure, or may comprise one or more corrugated foils. An insert consisting of a stack of corrugated foils and flat foils would preferably be bonded together before insertion, for example being spot welded together. The insert may occupy most or all of the length of the channel, although alternatively it may occupy only part of the length of the channel. Such inserts are typically of length at least 50 mm, more preferably at least 150 mm; and of a cross-sectional shape and size that just fits within the channel. Such inserts provide a large surface area for catalyst within a small volume, and the insert may have sufficiently high voidage that the flow of reactants through the channel is not unduly impeded. The invention is equally applicable to inserts of different structures, for example an insert comprising a metal foam or a metal mesh. In each case such a metal structure may be coated with catalytic material, typically in conjunction with a ceramic support coating.

The invention, in another aspect, provides a method of inserting inserts into channels of a chemical reactor using such an insertion apparatus. The method may further comprise the step of pushing a second insert through the guide element into the same channel, where a channel is required to accommodate two inserts end to end. In one such situation a channel contains both a catalyst-containing insert and an insert that does not contain a catalyst.

The pushing member may have a resilient plastic end face that abuts the catalytic insert rather than a hard metal end face, to avoid damaging the end of the insert, for example a polypropylene end face. The pushing member may incorporate a force sensor, and operation of the insertion mechanism is stopped if the measured force exceeds a threshold. The threshold may be varied during the insertion of each insert.

The invention will now be further and more particularly described, by way of example only, and with reference to the accompanying drawings in which:

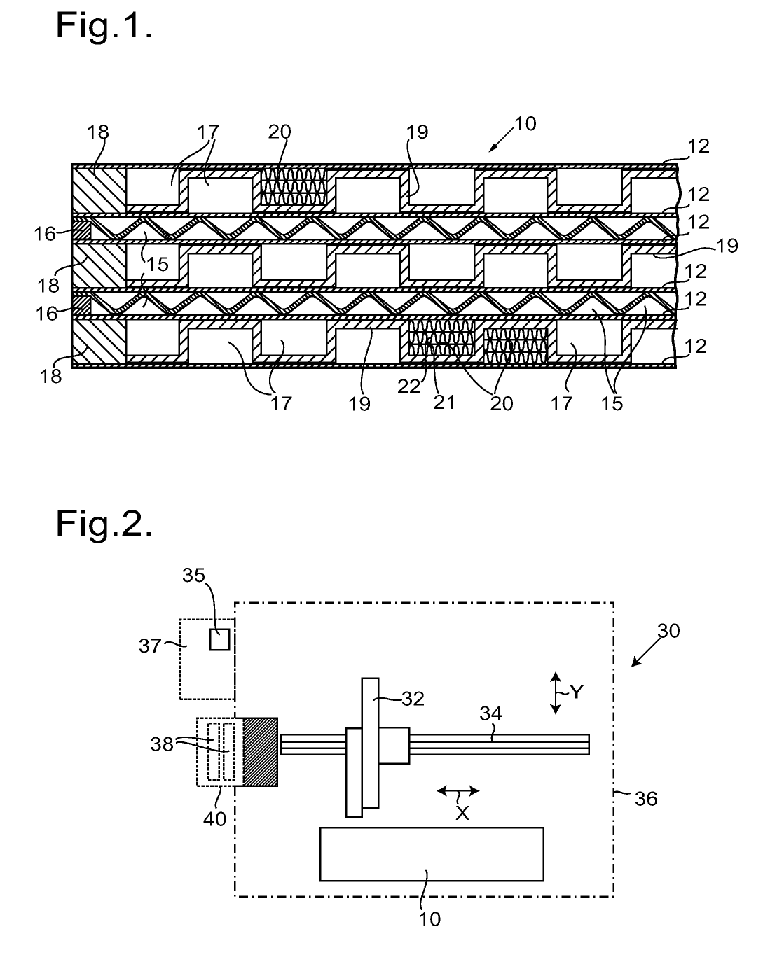

FIG. 1 shows an end view of a reactor;

FIG. 2 shows a schematic plan view of an insertion apparatus;

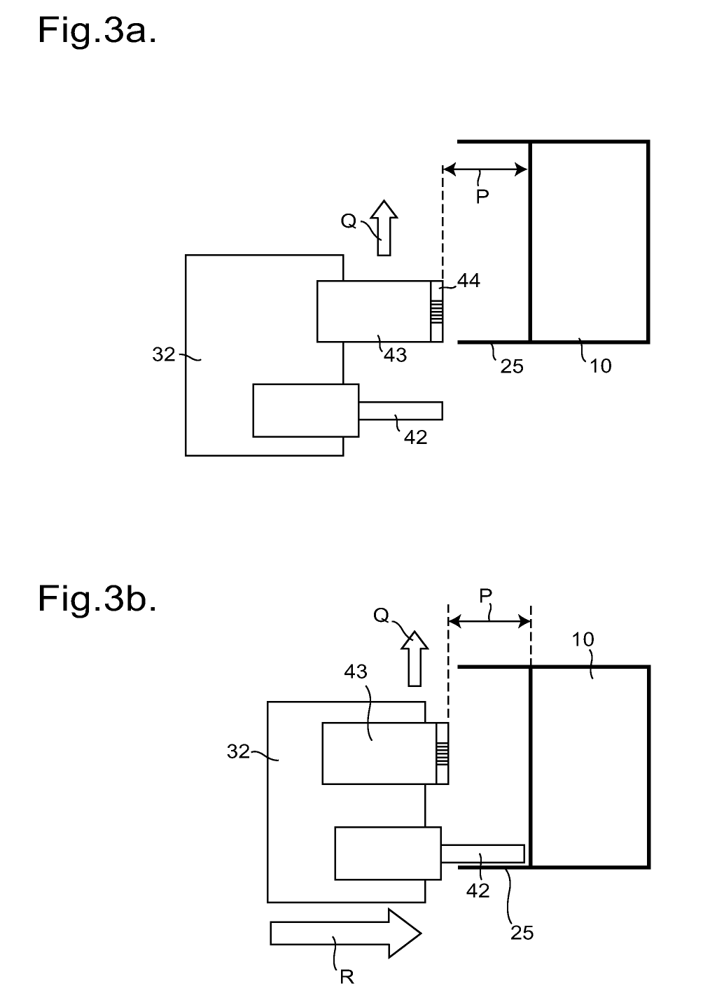

FIG. 3a and FIG. 3b show schematic plan views of the insertion mechanism and camera mechanism of the insertion apparatus of FIG. 2 at successive positions during operation;

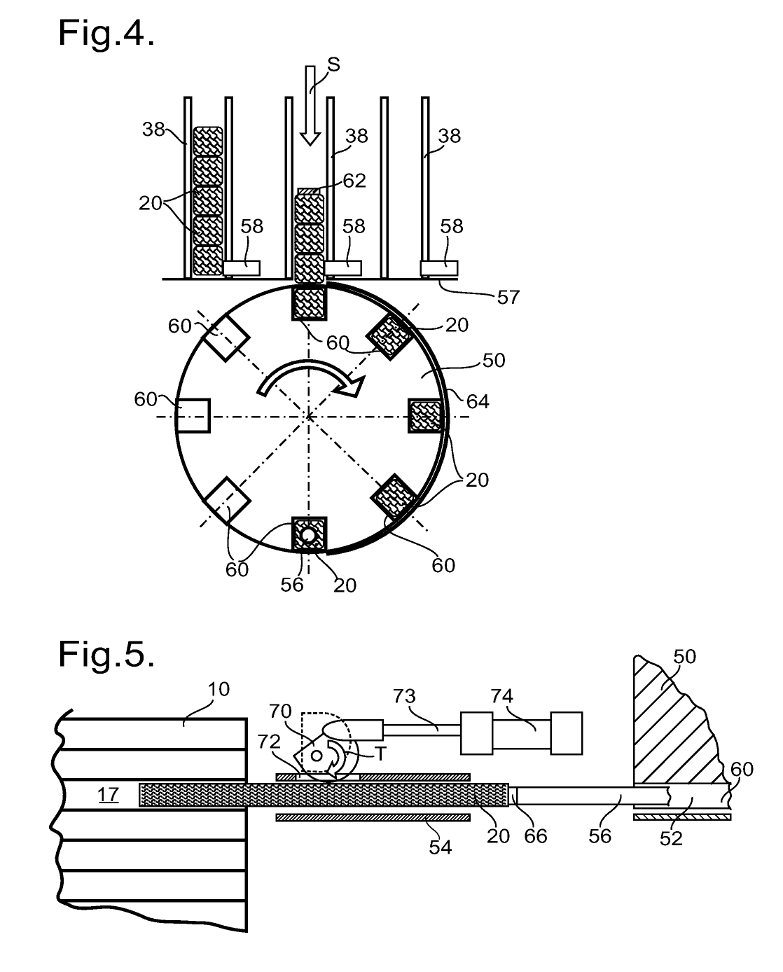

FIG. 4 shows an end view of a feeding mechanism for inserts, forming part of the insertion mechanism of FIGS. 2a and 2b;

FIG. 5 shows a side view of part of the insertion mechanism of FIGS. 2a and 2b;

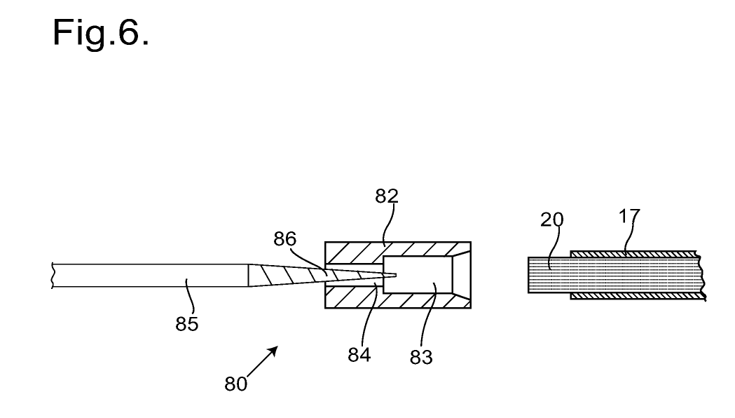

FIG. 6 shows a removal mechanism forming part of the insertion apparatus of FIG. 1.

It will be appreciated that the invention is applicable to a wide range of different reactors, of the type that may be referred to as a compact catalytic reactor, with multiple flow channels for two different fluids. By way of example, FIG. 1 shows a reactor block 10 suitable for performing Fischer-Tropsch synthesis, the reactor block 10 being shown in section and only in part. The reactor block 10 consists of a stack of flat plates 12 of thickness 1 mm spaced apart so as to define channels 15 for a coolant fluid alternating with channels 17 for the Fischer-Tropsch synthesis. The coolant channels 15 are defined in addition by sheets 14 of thickness 0.75 mm shaped into flat-topped sawtooth corrugations, with solid edge strips 16. The channels 17 for the Fischer-Tropsch synthesis are sealed by solid edge bars 18 and are defined in addition by sheets 19 of thickness 1.0 mm shaped into castellations of height typically in the range of 4 mm to 12 mm, for example 5 mm. In this example the resulting channels 17 are of width 10 mm and of height 5 mm; in an alternative example the channels 17 are of width 7 mm and of height 6 mm. The channels 17 extend straight through the reactor block 10 from one face to the opposite face. Within each of the channels 17 for Fischer-Tropsch synthesis is provided a catalytic insert 20. By way of example this insert 20 may comprise a stack of flat foils 21 and corrugated foils 22 each of thickness typically in the range from 20-150 μm, for example 50 μm, with a ceramic coating acting as a support for the catalytic material (only three such inserts 20 are shown). In the figure each insert 20 consists of two generally flat foils 21 (which may in practice define corrugations with an amplitude of say 0.1 mm for greater rigidity), separating three longitudinally corrugated foils 22. An alternative insert 20 might consist of a single corrugated foil whose corrugations are substantially the height of the channel 17, or alternatively two corrugated foils separated by a flat foil.

The foils may be fabricated from a steel alloy that forms an adherent surface coating of aluminium oxide when heated, for example an aluminium-bearing ferritic steel such as iron with 15% chromium, 4% aluminium, and 0.3% yttrium (eg Fecralloy™). When this alloy is heated in air it forms an adherent oxide coating of alumina, which protects the alloy against further oxidation and against corrosion. Where the ceramic coating is of alumina, this appears to bond to the oxide coating on the surface.

In an alternative example, not illustrated, the foils that provide the substrate for the catalyst may be replaced with a wire mesh or a felt sheet, which may be corrugated, dimpled or pleated. It will be appreciated that one or more catalyst inserts 20 are provided throughout the length of the reaction channel 17 where catalytic reaction is to occur. The reactor channel 17 may for example be of length 150 mm or more, for example up to 1 m, such as 600 mm; and consequently the insert 20 will be of comparable length—for example two inserts 20 each of length 300 mm might be inserted end to end in a channel of length 600 mm.

In FIG. 1 the reaction channels 17 are wider (in the direction parallel to the flat plates 12) than they are high, but the reaction channels 17 might instead be of square cross-section, or alternatively they might be higher than they are wide. The catalytic inserts 20 described above consist of one or more corrugated foils whose centre plane is parallel to the flat plates 12, but alternatively the corrugated foil or foils may be arranged with their centre plane orthogonal to the flat plates 12. If the reaction channels 17 are narrower (in the direction parallel to the flat plates 12) than they are high, then it may be more convenient to arrange the corrugated foil or foils with their centre planes orthogonal to the flat plates 12.

It is to be emphasised that FIG. 1 shows only a part of the reactor block 10. The number of channels 17 into which inserts 20 must be inserted depends on the size of the reactor block 10, but for example if the end face of the reactor block 10 is 0.36 m by 0.36 m there may be more than one thousand such channels 17. With the structure described above, the insert 20 has a width and height just less than that of the channel 17 (which is of width 10 mm and height 5 mm, or might instead be of width 7 mm and height 6 mm, for example), with a clearance typically no more than 0.3 mm in each direction, and more preferably no more than 0.1 mm clearance; and as described above each insert may be of length 300 mm. Since each foil 21 or 22 is of thickness only about 50 microns, it is not a rigid object; the foils 21 and 22 may therefore be bonded together, for example by spot welding, which increases the rigidity of the insert 20. Inserting such a large number of catalyst inserts 20 is not a simple matter.

An automated insertion apparatus 30 is shown in FIG. 2, consisting of a robot arm 32 movable along a gantry 34 as indicated by arrow X; the gantry 34 itself can move in a direction orthogonal to its length, as indicated by arrow Y. The robot arm 32 carries components described below, and can raise and lower these components. The robot arm 32 is enclosed within a safety enclosure 36, a control panel 37 being provided outside the enclosure 36. The control panel 37 includes a computer 35 to control operation of the insertion apparatus 30. A reactor block 10 into which catalytic inserts 20 are to be inserted is set up within the enclosure 36 alongside the robot arm 32. The inserts 20 are provided in magazines 38, each of which contains a stack of several inserts 20. A drawer 40 enables an operator to exchange empty magazines 38 for full magazines 38 without entering the enclosure 36; the drawer 40 is adjacent to one end of the path provided by the gantry 34.

Referring now to FIG. 3a, which shows some features of the robot arm 32 in plan view and in greater detail, in this example the reactor block 10 includes a peripheral wall 25 which projects 80 mm beyond the face of the reactor block 10. The robot arm 32 includes an insertion mechanism 42 and a digital camera 43, the camera 43 being provided with a ring light 44 around its lens to ensure that the face of the reactor block 10 is illuminated. The insertion apparatus 30 is arranged to repeatedly scan across the width of the reactor block 10, inserting an insert 20 into each channel 17; that is to say (with reference to FIG. 1), inserts 20 are inserted into each channel 17 defined by a first sheet 19, and then into the channels 17 defined by the next sheet 19 in the stack, and then into the channels 17 defined by the next sheet 19 in the stack, and so on. The camera 43 is at the same height as the insertion mechanism 42, so it is also scanned across the face of the reactor block 10 similarly. The insertion procedure is described in more detail below.

In a starting position, shown in FIG. 3a, the camera 43 is in a distance P from the face of the reactor block 10 at which the face of the reactor block 10 is in focus, and P is greater than 80 mm so the camera is clear of the peripheral wall 25. The insertion mechanism 42 is also clear of the peripheral wall 25. The robot arm 32 moves along the gantry 34, moving the insertion mechanism 42 and the digital camera 43 in the direction indicated by the arrow Q, and at the same time the images from the camera 43 are supplied to the computer 35, which thereby acquires positional information about each channel 17, and stores this data.

As indicated in FIG. 3b, when the robot arm 32 reaches the position at which the insertion mechanism 42 is aligned with the first of the channels 17, the gantry 34 moves towards the face of the reactor block 10 as indicated by the arrow R and at the same time the camera 43 is retracted. This ensures that the distance from the camera 43 to the reactor block 10 remains P, but that the front end of the insertion mechanism 42 is adjacent to the channel 17. The robot arm 32 aligns the insertion mechanism 42 with the first channel 17, using the positional information from the computer 35, and then moves further along the gantry 34 in the direction of the arrow Q to the next channel 17. The camera 43 continues to acquire positional information about each channel 17, and to supply this data to the computer 35, until it reaches the last channel 17 in that row, and will then pass beyond the peripheral wall 25 and cease to acquire positional information. The robot arm 32 continues to scan along the gantry 34, and aligns the insertion mechanism 42 with each channel 17 in the row.

When the required insert 20 has been inserted into each channel 17 in the row, the gantry 34 is retracted away from the face of the reactor block 10, and the camera 43 is moved forward; the robot arm 32 then moves back along the gantry 34 to the starting position shown in FIG. 3a, and then moves down (or up) so the camera 43 and the insertion mechanism 42 are at the height of the next row of channels 17. The above procedure is then repeated, until every row has been filled. Hence an insert 20 can be inserted into every channel 17 of the reactor block 10.

Referring now to FIGS. 4 and 5, the insertion mechanism 42 is shown in greater detail. Inserts 20 from magazines 38 are fed by a rotary drum 50 to an output location 52, the output location 52 being aligned with a guide channel 54. The robot arm 32 ensures that the output location 52 and the guide channel 54 are aligned with the next empty channel 17, and the end of the guide channel 54 is adjacent to the face of the reactor block 10. In this aligned position an insertion rod 56 is arranged to push on the end of the insert 20, pushing it through the guide channel 54 and so into the channel 17 of the reactor block 10.

Referring in more detail to FIG. 4, an array of magazines 38 (only three are shown) are arranged on a support plate 57 above the rotary drum 50. Each magazine 38 initially encloses several inserts 20, typically at least twenty (only five are shown in the left-hand magazine 38), the bottom-most insert 20 in each magazine 38 being secured by a spring-loaded holding block 58. The rotary drum 50 is supported on spindle bearings, and is made of a case-hardening material which has been case hardened to a depth of 0.75 mm and heat treated, and it defines eight parallel rectangular shallow slots 60 equally spaced around its periphery, each slot 60 being of such a size as to accommodate one of the inserts 20, and providing a clearance of at least 0.2 mm to ensure the insert 20 can freely slide along the slot 60. The rotary drum 50 is rotated stepwise, 45° at a time, so whenever it stops there is one rectangular slot 60 at the top, and one rectangular slot at the bottom (as shown), the bottom position being the output location 52 as described above.

At the same time as the insert 20 from the bottom position is being inserted into the channel 17, an insert 20 is pushed into the rectangular slot 60 at the top of the rotary drum. This entails the spring-loaded holding block 58 being released, and a pneumatically actuated pusher blade 62 pushing down on the inserts 20 in the magazine 38, as indicated by the arrow S, so ensuring the insert 20 is fully located within the rectangular slot 60. The right-hand half (as shown) of the rotary drum 50 is surrounded by a close-fitting cover 64, so ensuring that as the rotary drum 50 rotates the inserts 20 do not fall out of the rectangular slots 60.

When the magazine 38 directly above the rotation axis of the rotary drum 50 is empty, the pusher blade 62 is withdrawn, and the magazines 38 are moved along to the right (as shown) so that the next full magazine 38 is in the position directly above the rotation axis of the rotary drum 50.

Referring now to FIG. 5, the insertion rod 56 is arranged to push the insert 20 out of the rectangular slot 60 at the bottom of the rotary drum 50, through the guide channel 54 and so into the channel 17. Although the rotary drum 50, the guide channel 54 and the face of the reactor block 10 are shown spaced apart, they are actually much closer together. The guide channel 54 in this example defines a channel of rectangular cross-section, the channel being slightly tapered towards the end adjacent to the face of the reactor block 10, the narrowest end being slightly smaller than the dimensions of the reaction channel 17. The guide channel 54 may be of a low friction plastic material such as polytetrafluoroethylene, or of a hard material, such as stainless steel. The insert 20 is of resilient material, and the effect of the guide channel 54 is to squeeze the insert 20 sufficiently to ensure that it does not catch on the edges of the channel 17 as it is inserted.

The insertion rod 56 includes a pressure sensor 66, whose signals are provided to the computer 35. This enables the computer 35 to detect if the channel 17 is blocked, or if the insert 20 jams during insertion. The insertion rod 56 can be arranged to move the insert at a speed which varies, starting at a slow speed until the leading end of the insert 20 has entered the channel 17, and then speeding up. If a problem is detected, then the computer 35 ceases the insertion operation, and withdraws the insertion rod 56. The problem may be detected from an increase in the signals from the pressure sensor 66. The threshold that is taken to indicate such a problem may also vary during insertion, increasing as a greater length of insert is within the channel. If no such problems arise, then when the insert 20 is fully inserted the insertion rod 56 is withdrawn, which may be carried out at full speed. The apparatus can then moved on to the next reactor channel 17.

As shown in FIG. 5, a snail cam 70 is pivotally mounted above the guide channel 54, its initial position being shown by a broken line, and when turned projects through a slot 72 in the top of the guide channel 54. The snail cam 70 has a slightly serrated surface. The snail cam 70 is linked to an actuator rod 73 operated by a pneumatic cylinder 74.

If, when a blockage or a jam is sensed, part of the insert 20 is within the portion of the guide channel 54 below the snail cam 70, then the insert 20 can be removed. Firstly the pneumatic cylinder 74 moves the actuator rod 73 so the snail cam 70 pivots, as indicated by the arrow T, so the serrated surface of the snail cam 70 comes into contact with the insert 20, and presses down on it. The gantry 34 is then withdrawn, moving the robot arm 32 and with it the guide channel 54 away from the face of the reactor block 10. The snail cam 70 clamps the insert 20 to the guide channel 54, and the shape of the snail cam 70 is such that the greater the tension in the insert 20 the greater is the clamping force. Hence the insert 20 is pulled out from the channel 17. The pneumatic cylinder 74 is then extended so that the snail cam 70 turns in the opposite direction, so it is no longer in contact with the insert 20; the insertion rod 56 may then be actuated to push the insert 20 out of the guide channel 54, into a storage space for rejected inserts 20. The robot arm 32 is then returned to the operating position, and the insertion procedure continues at the next channel 17.

Referring now to FIG. 6, the robot arm 32 also carries a removal device 80 which may be utilised if an insert 20 becomes jammed with only a short length, for example less than 10 mm or less than 20 mm, projecting from the end of the channel 17, so that the snail cam 70 cannot grip the insert 20. The removal device 80 includes a frame 82 defining a socket 83 to fit the end of the insert 20, the socket 83 having a tapered mouth, and the frame 82 also defining a cylindrical aperture 84 communicating with the rear end of the socket 83 at the opposite end of the frame 82, and also includes a control rod 85 with a self-tapping screw 86 at one end, which can pass through the cylindrical aperture 84. The length of the screw 86 is a few mm longer than the length of the socket 83. The screw 86 can be rotated, and is movable between a retracted position (as shown); an engaged position in which the entire length of the screw 86 is within the socket or beyond the mouth of the socket 83; and a projecting position in which the entire length of the screw 86 projects beyond the mouth of the socket 83.

If a partly-projecting insert 20 is to be removed from a channel 17, the frame 82 would be moved forward with the screw 86 in the retracted position (as shown), so the end of the insert 20 fits within the socket 83. The control rod 85 would then be operated to press the screw 86 onto the end of the insert 20 while the screw 86 is turned, so that the screw 86 engages with the insert 20. When the screw 86 reaches the engaged position, the removal device 80 is firmly fixed to the insert 20. The removal device 80 would then be retracted, pulling the insert 20 out of the channel 17. The insert 20 can then be disconnected from the removal device 80 by unscrewing the screw 86, returning the screw 86 to its retracted position, so the insert 20 is no longer fixed in the socket 83.

The removal device 80 is also suitable for use if an insert 20 is fully inserted into a channel 17, but is to be removed. In this case the frame 82 would be moved forward until the socket 83 is adjacent to and aligned with the end of the channel 17. The screw 86 would then be turned while being pressed on to the end of the insert 20, so that the screw 86 engages with the insert 20 and projects beyond the mouth of the socket 83. When the screw 86 is in the projecting position, it firmly engages the insert 20. The screw 86 would then be withdrawn to the engaged position, pulling the end of the insert 20 out of the channel 17 and into the socket 83. The removal device 80 would be retracted as described above, pulling the insert 20 completely out of the channel 17.

It will be appreciated that the computer 35 would be initially provided with information relating to the layout of the reactor, including the number of channels into which a foil or foils need to be inserted. This reactor layout information may be stored in a memory or other suitable storage means. In the course of operation the computer 35 keeps a record of those channels 17 into which an insert 20 has been inserted, and also keeps a record of those channels 17 into which it was not possible to insert an insert 20. Hence the operator can be provided with details relating to blocked or mis-sized channels that will require manual attention when the remaining channels 17 in the reactor block 10 have been automatically filled. This information can then be presented to an operator.

It will be understood that the insertion apparatus 30 is described above by way of example only, and that it may be modified in various ways while remaining within the scope of the present invention. For example the insertion apparatus 30 uses a rotary drum 50 as a transport mechanism to move support channels (rectangular slots 60) repeatedly between an input location adjacent to the feed position and an output location; the rotary drum 50 may be replaced by a different transport mechanism such as a belt or chain which may pass around rollers, the belt or chain carrying support channels to locate inserts 20.

The apparatus can be used to introduce catalytic inserts into a new reactor or to replace catalytic inserts during reactor reconditioning. The lifespan of a reactor may be in the region of 10 years, whereas the catalyst life may be only in the region of three years. It will therefore be necessary to recondition a reactor, by providing a new set of catalytic inserts 20 three or four times within the life of a reactor.

If the reactor is one in which both an exothermic reaction and an endothermic reaction take place in separate channels, for example a steam methane reforming reactor in which there are reactor channels for combustion and reactor channels for steam methane reforming, the different sets of channels may be accessible from opposite sides of the reactor. Therefore, two automated insertion apparatuses 30 as described above may be used together, one at either side of the reactor block, one inserting catalytic inserts for the exothermic reaction and the other inserting catalytic inserts for the endothermic reaction.

Analogously, even if all the reaction channels require the same catalytic insert, for example in a Fischer-Tropsch reactor, there may be access to both ends of the reaction channels 17, and in this case the catalyst inserts can be inserted from either side of the reactor block. In this case, two sets of apparatus 30 may be used simultaneously inserting catalytic inserts into the same reactor channels. This is especially advantageous in the situation where the reactor channel length is double the length of the catalyst insert. In this case, each apparatus can insert one catalytic insert into each channel.

1. An insertion apparatus for inserting at least one insert into each of a plurality of reactor channels, the apparatus comprising:
means to support a magazine at a feed position, the magazine being configured to locate a multiplicity of inserts;
a transport mechanism defining at least two support channels each configured to hold a single insert, and means to transport each support channel repeatedly between an input location adjacent to the feed position and an output location;
a feed mechanism to feed one insert from a magazine at the feed position into the support channel of the transport mechanism at the input location;
a transfer mechanism for transferring an insert from the output location of the transport mechanism into a reactor channel; and
an alignment mechanism to ensure that the insert that is being transferred into a reactor channel is aligned with the reactor channel.

2. An apparatus as claimed in claim 1 wherein the transport mechanism defines a multiplicity of support channels which are arranged to pass through at least one intermediate location between the input location and the output location, and arranged such that the support channels that hold an insert are moved stepwise between successive locations.

3. An apparatus as claimed in claim 1 wherein the transport mechanism comprises a rotary support structure having an axis of rotation and defining a multiplicity of support channels each configured to hold a single insert, the support channels being at locations that in transverse cross-section define a regular polygon centred on the axis of rotation.

4. An apparatus as claimed in claim 3 wherein the rotary support structure is a cylindrical drum with a multiplicity of support channels equally spaced around its periphery.

5. An apparatus as claimed in claim 4 wherein the drum is provided with a cover to ensure that inserts cannot fall out of the support channels as the drum rotates.

6. An apparatus as claimed in claim 1 wherein the dimensions of a support channel are such as to ensure the insert can easily slide along the channel.

7. An apparatus as claimed in claim 1 also comprising a guide element to guide the movement of an insert as it is inserted into the reaction channel.

8. An apparatus as claimed in claim 7 wherein the guide element provides an aperture through which the insert is arranged to pass, wherein the aperture is tapered along its length.

9. An apparatus as claimed claim 1 wherein the transfer mechanism is arranged to transfer the insert into the channel at an insertion speed which varies during the course of the insertion.

10. An apparatus as claimed in claim 9 wherein the insertion speed is increased once the front end of the insert is within the reactor channel.

11. An apparatus as claimed in claim 1 also comprising a mechanism for removing an insert from a reactor channel.

12. An apparatus as claimed in claim 11 wherein the insert removing mechanism comprises a clamp to secure the insert within a guide element.

13. An apparatus as claimed in claim 12 wherein the clamp comprises a cam.

14. An apparatus as claimed in claim 9 wherein the insert removing mechanism comprises a fixing bar with a self-tapping screw at one end, and a frame defining a socket to fit the end of the insert, the socket having a tapered mouth, and defining an aperture at the opposite end of the frame, the self-tapping screw being adapted to extend through the aperture to project within or beyond the socket.

15. An apparatus as claimed in claim 1 also comprising a control system comprising: a microprocessor configured to receive data from one or more sensors, an actuator configured to control the transfer mechanism and an actuator configured to provide alignment between the transfer mechanism and a reactor channel.

16. A method of inserting inserts into channels of a chemical reactor, by use of an insertion apparatus comprising:
means to support a magazine at a feed position, the magazine being configured to locate a multiplicity of inserts;
a transport mechanism defining at least two support channels each configured to hold a single insert, and means to transport each support channel repeatedly between an input location adjacent to the feed position and an output location;
a feed mechanism to feed one insert from a magazine at the feed position into the support channel of the transport mechanism at the input location;
a transfer mechanism for transferring an insert from the output location of the transport mechanism into a reactor channel; and
an alignment mechanism to ensure that the insert that is being transferred into a reactor channel is aligned with the reactor channel;
the method comprising loading a multiplicity of inserts in the magazine, and operating the feed mechanism and the transfer mechanism to transfer inserts from the magazine and through the alignment mechanism into reactor channels.

17. A method as claimed in claim 16 further comprising the step of pushing a second insert into each channel, using the insertion apparatus.
